(19) United States
(12) Patent Application Publication
(10) Pub. No.: US 2025/0296356 A1
(43) Pub. Date: Sep. 25, 2025

(54) TREATMENT-AGENT LIQUID APPLICATOR AND IMAGE FORMING APPARATUS

(71) Applicants: Takayuki SEKI, Kanagawa (JP); Kohki ASADA, Tokyo (JP); Kanta FURUYA, Tokyo (JP); Kenji NOZAWA, Kanagawa (JP); Hirotaka KOBAYASHI, Kanagawa (JP); Isao MATSUSHIMA, Kanagawa (JP); Takashi EBIHARA, Ibaraki (JP); Ryusaku HIDA, Kanagawa (JP); Keita ACHI, Kanagawa (JP); Hiroki ISHIHARA, Kanagawa (JP)

(72) Inventors: Takayuki SEKI, Kanagawa (JP); Kohki ASADA, Tokyo (JP); Kanta FURUYA, Tokyo (JP); Kenji NOZAWA, Kanagawa (JP); Hirotaka KOBAYASHI, Kanagawa (JP); Isao MATSUSHIMA, Kanagawa (JP); Takashi EBIHARA, Ibaraki (JP); Ryusaku HIDA, Kanagawa (JP); Keita ACHI, Kanagawa (JP); Hiroki ISHIHARA, Kanagawa (JP)

(73) Assignee: Ricoh Company, Ltd., Tokyo (JP)

(21) Appl. No.: 19/082,579

(22) Filed: Mar. 18, 2025

(30) Foreign Application Priority Data
Mar. 22, 2024 (JP) 2024-045878

(51) Int. Cl. B41J 11/00; B05C 1/08

(52) U.S. Cl. CPC B41J 11/0015; B05C 1/0813; B05C 1/0873

(57) ABSTRACT

A treatment-agent liquid applicator includes an application roller to apply a treatment agent to a medium to be conveyed to an image forming apparatus, a pressure roller to press the medium against the application roller, a supply roller to supply the treatment agent to the application roller, and circuitry configured to rotate the application roller for a duration of time, from when job information is acquired by the image forming apparatus, to when the medium reaches the application roller.

### CROSS-REFERENCE TO RELATED APPLICATIONS

This patent application is based on and claims priority pursuant to 35 U.S.C. § 119 (a) to Japanese Patent Application No. 2024-045878, filed on Mar. 22, 2024, in the Japan Patent Office, the entire disclosure of which is hereby incorporated by reference herein.

### BACKGROUND

### Technical Field

Exemplary aspects of the present disclosure relate to a treatment-agent liquid applicator and an image forming apparatus.

### Related Art

In image forming apparatuses in which an image is formed and printed on a medium by an inkjet method, a technique for enhancing image quality by application of a treatment agent to a medium in an image forming process is known. Such an apparatus includes an application roller containing a treatment agent and a conveyance roller disposed on the side opposite the application roller via a medium. Prior to the image forming process, in general, the treatment agent is applied to the medium by the application roller when the medium passes through a nip portion between the application roller and the conveyance roller while being supported by the application roller and the conveyance roller.

Such a pre-applying liquid application device in which a treatment agent is applied to a medium by an application roller includes the application roller that applies treatment-agent liquid to a medium prior to image formation, a squeeze roller that presses the application roller, a treatment-agent liquid supplier that supplies the treatment-agent liquid to a nip portion between the application roller and the squeeze roller, and a squeeze adjuster that adjusts a pressing force of the squeeze roller against the application roller. The squeeze adjuster makes an adjustment such that the pressing force of the squeeze roller is approximately proportional to a conveyance speed of the medium inside the pre-applying liquid application device.

### SUMMARY

In an aspect of the present disclosure, a treatment-agent liquid applicator is provided that includes an application roller to apply a treatment agent to a medium to be conveyed to an image forming apparatus, a pressure roller to press the medium against the application roller, a supply roller to supply the treatment agent to the application roller, and circuitry configured to rotate the application roller for a duration of time, from when job information is acquired by the image forming apparatus, to when the medium reaches the application roller.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating one example of an overall configuration of an image forming apparatus according to one embodiment of the present disclosure;

FIG. 2 is a diagram illustrating another example of an overall configuration of an image forming apparatus;

FIG. 3 is a diagram illustrating one example of a configuration of a pre-applying unit of the image forming apparatus;

FIG. 4 is a diagram illustrating one example of a configuration of an application unit of the pre-applying unit of the image forming apparatus;

FIG. 5 is a diagram illustrating one example a hardware configuration of the image forming apparatus;

FIG. 6 is a diagram illustrating an operation for controlling an application roller of the application unit of the pre-applying unit in the image forming apparatus;

FIG. 7 is a diagram illustrating one example of a function block configuration of the image forming apparatus;

FIG. 8 is a diagram illustrating a preparation state prior to application of a treatment agent in an application unit of a pre-applying unit of an image forming apparatus in a comparative example;

FIG. 9 is a diagram illustrating a state when the treatment agent is applied to a medium in the application unit of the pre-applying unit of the image forming apparatus in the comparative example;

FIG. 10 is a diagram illustrating a state in which banding-shaped application unevenness is generated on the medium to which the treatment agent has been applied by the pre-applying unit of the image forming apparatus in the comparative example;

FIG. 11 is a diagram illustrating a non-operating state in the application unit of the pre-applying unit of the image forming apparatus according to the embodiment of the present disclosure;

FIG. 12 is a diagram illustrating a preparation state prior to application of a treatment agent in the application unit of the pre-applying unit of the image forming apparatus;

FIG. 13 is a diagram illustrating a state when the treatment agent is applied in the application unit of the pre-applying unit of the image forming apparatus; and

FIG. 14 is a diagram illustrating a state of the medium to which the treatment agent has been applied by the pre-applying unit of the image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, a treatment-agent liquid applicator and an image forming apparatus according to an embodiment of the present disclosure are described with reference to the drawings. Note that the present disclosure is not limited to the following embodiment, and components in the following embodiment include matter that can be easily conceived by a person skilled in the art, matter that is substantially the same as that in the following embodiment, and matter that is in a range equivalent to that in the following embodiment. Moreover, various omissions, replacements, changes, and a combination of the components can be made within the scope of the present disclosure.

### (Overall Configuration of Image Forming Apparatus)

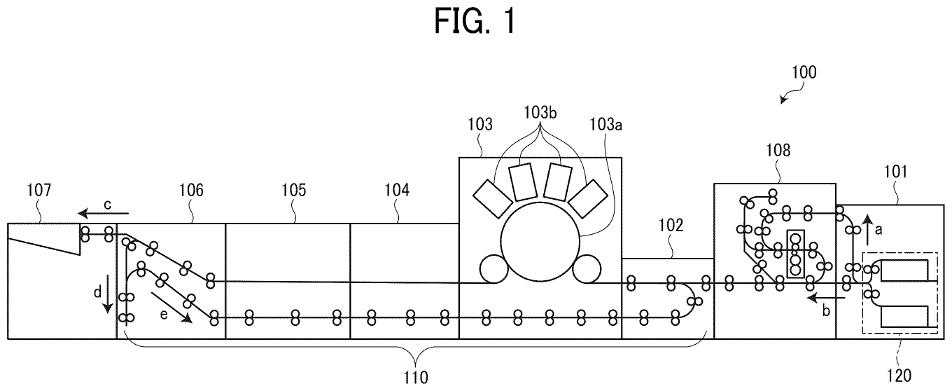

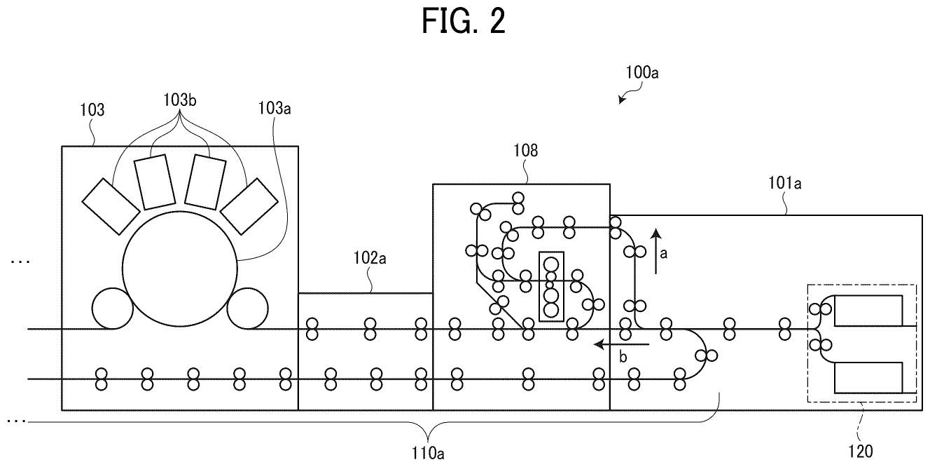

FIG. 1 is a diagram illustrating one example of an overall configuration of an image forming apparatus 100 according to an embodiment of the present disclosure. FIG. 2 is a diagram illustrating another example of an overall configuration of an image forming apparatus 100a according to the embodiment of the present disclosure. The overall configuration of the image forming apparatus 100 according to the present embodiment is described with reference to FIGS. 1 and 2.

The image forming apparatus 100 illustrated in FIG. 1 is a commercial printing machine that forms an image on a medium (a recording medium) such as a sheet by an inkjet method. The image forming apparatus 100 includes a sheet feeding unit 101, a pre-applying unit 108 (a treatment-agent liquid applicator), a registration unit 102, an image forming unit 103, a drying unit 104, a cooling unit 105, a reverse unit 106, and a sheet ejection unit 107.

The sheet feeding unit 101 separates and conveys media one by one from a sheet feed tray 120. The medium which has been separated and conveyed by the sheet feeding unit 101 is fed to the pre-applying unit 108. The sheet feeding unit 101 can switch between medium conveyance paths a and b. A medium is conveyed along the path “a” illustrated in FIG. 1 if a treatment agent is pre-applied to the medium in the pre-applying unit 108, whereas a medium is conveyed along the path b illustrated in FIG. 1 if a treatment agent is not pre-applied to the medium in the pre-applying unit 108. In the present embodiment, since the description is given based on the premise that a treatment agent is pre-applied to a medium in the pre-applying unit 108, the medium is conveyed along the path a by the sheet feeding unit 101.

The pre-applying unit 108 (a treatment-agent liquid applicator) applies a pre-applying treatment agent to one side or two sides of the medium fed and conveyed along the path a from the sheet feeding unit 101. The treatment agent is applied to the medium by the pre-applying unit 108, and the resultant medium is conveyed to the registration unit 102.

The registration unit 102 appropriately corrects a position of the medium conveyed from the pre-applying unit 108. A position of the medium is corrected by the registration unit 102, and then the medium is conveyed to the image forming unit 103.

The image forming unit 103 forms and prints an image by discharging ink to the medium conveyed from the registration unit 102. As illustrated in FIG. 1, the image forming unit 103 includes an image formation conveyance drum 103a and an inkjet head 103b (a discharge head).

The image formation conveyance drum 103a is a drum that is rotated to convey the medium conveyed from the registration unit 102 toward the inkjet head 103b. The inkjet head 103b is a discharge head that discharges ink to the medium conveyed by the image formation conveyance drum 103a to form and print an image on the medium.

The medium on which the image has been formed and printed by the image forming unit 103 is conveyed to the drying unit 104.

The drying unit 104 dries the medium conveyed from the image forming unit 103. In the example of the image forming apparatus 100 illustrated in FIG. 1, one drying unit 104 is disposed. However, the image forming apparatus 100 is not limited thereto. A plurality of drying units 104 may be disposed depending on drying conditions. The medium which has been dried by the drying unit 104 is conveyed to the cooling unit 105.

The cooling unit 105 cools the dried medium conveyed from the drying unit 104. The medium cooled by the cooling unit 105 is conveyed to the reverse unit 106.

If printing is to be performed on two sides of the medium conveyed from the cooling unit 105, the reverse unit 106 switches back the medium in a path d illustrated in FIG. 1 to reverse the medium, and conveys the reversed medium to a two-side conveyance path 110 via a path e illustrated in FIG. 1. The medium conveyed to the two-side conveyance path 110 is fed to the registration unit 102 again, and an image is formed and printed on a second surface that is the back surface of a first surface on which an image has been already formed and printed in the image forming unit 103. If printing is performed on only one side of the medium conveyed from the cooling unit 105, the reverse unit 106 conveys the medium to the sheet ejection unit 107 via a path c illustrated in FIG. 1.

The sheet ejection unit 107 ejects the medium conveyed from the reverse unit 106 to an ejection tray.

In the example of the image forming apparatus 100 illustrated in FIG. 1, if a medium that undergoes two-side printing is reversed by the reverse unit 106, the medium is fed again by the registration unit 102, that is, the medium is fed again on a downstream side of the pre-applying unit 108. However, the present embodiment can be applied to a configuration in which a medium is fed again on an upstream side of a pre-applying unit 108, as similar to the image forming apparatus 100a illustrated in FIG. 2. In the example of the image forming apparatus 100a illustrated in FIG. 2, a medium is fed again by a sheet feeding unit 101a on an upstream side of the pre-applying unit 108. In FIG. 2, since a configuration of each of units arranged on a downstream side of an image forming unit 103 is similar to a configuration illustrated in FIG. 1, an illustration thereof is omitted. After the pre-applying unit 108 pre-applies a treatment agent to a medium that has been separated and conveyed from a sheet feed tray 120 inside the sheet feeding unit 101a, a registration unit 102a corrects a position of the medium, and then the medium is conveyed to the image forming unit 103. If two-side printing is performed, the medium reversed by a reverse unit 106 as similar the configuration illustrated in FIG. 1 is fed again by the sheet feeding unit 101a on the upstream side of the pre-applying unit 108 via a two-side conveyance path 110a, and then is conveyed again to the pre-applying unit 108. The pre-applying unit 108 pre-applies a treatment agent on a second surface that is the back surface of a first surface on which a treatment agent had already been pre-applied and an image has been already formed and printed. Then, the image forming unit 103 forms and prints an image on the second surface.

### (Configuration of Pre-Applying Unit)

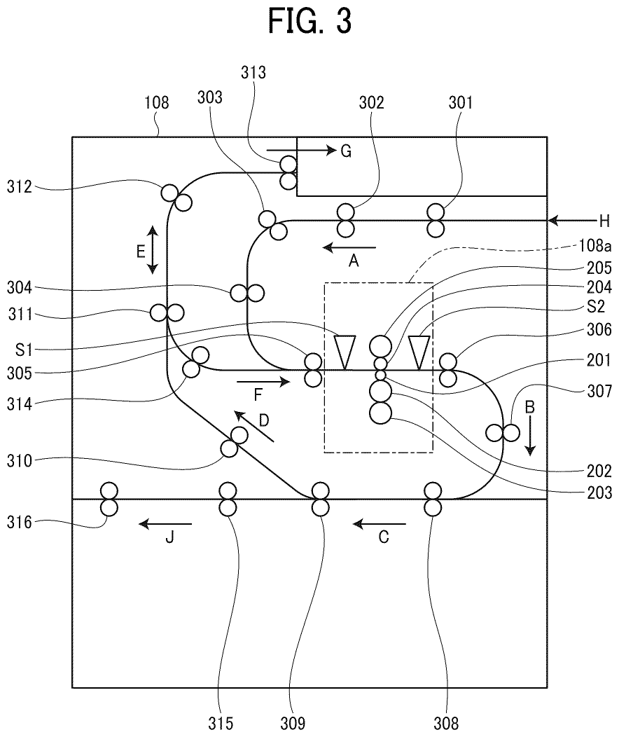

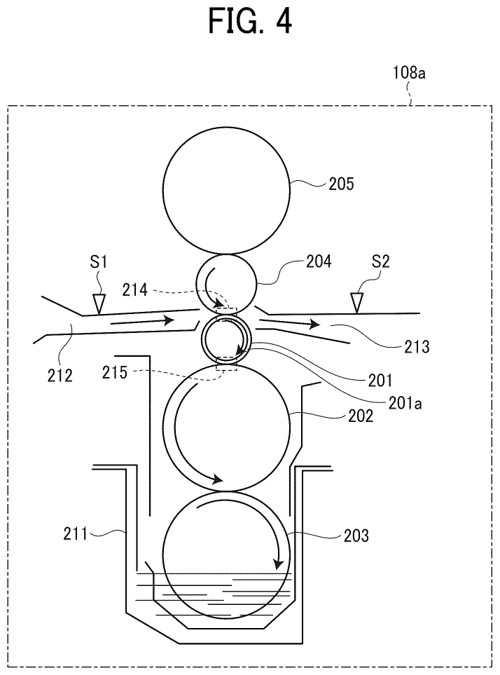

FIG. 3 is a diagram illustrating one example of a configuration of the pre-applying unit 108 of the image forming apparatus 100 according to the embodiment. FIG. 4 is a diagram illustrating one example of a configuration of an application unit 108a of the pre-applying unit 108 of the image forming apparatus 100. The configuration of the pre-applying unit 108 of the image forming apparatus 100 is described with reference to FIGS. 3 and 4.

As illustrated in FIG. 3, the pre-applying unit 108 includes the application unit 108a, inlet rollers 301 through 305, outlet rollers 306 through 309, purge rollers 310 through 313, a reentry inlet roller 314, and outlet rollers 315 and 316.

The application unit 108a applies a treatment agent to a medium that enters the pre-applying unit 108 from a direction H illustrated in FIG. 3 and is conveyed by the inlet rollers 301 through 305. A configuration of the application unit 108a is described in detail below.

The inlet rollers 301 through 305 convey the medium, which has entered the pre-applying unit 108 from the direction H, along a direction A illustrated in FIG. 3 to convey the medium to the application unit 108a.

The outlet rollers 306 through 309 convey the medium along directions B and C illustrated in FIG. 3. Herein, the medium to which the treatment agent has been applied in the application unit 108a is conveyed along directions B and C by the outlet rollers 306 through 309. If a treatment agent is applied to both sides of a medium, the treatment agent is applied to a first surface of the medium in the application unit 108a, and the resultant medium is conveyed via the outlet rollers 306 through 309. Then, a bifurcating claw (not illustrated) causes the medium to be conveyed along a direction D illustrated in FIG. 3 by the purge roller 310. On the other hand, if a treatment agent is applied to only one side of a medium, the treatment agent is applied to a first surface of the medium in the application unit 108a, and the resultant medium is conveyed via the outlet rollers 306 through 309. Then, the bifurcating claw (not illustrated) causes the medium to be conveyed along a direction J illustrated in FIG. 3 to the registration unit 102 by the outlet rollers 315 and 316.

The purge roller 310 is a conveyance roller that conveys the medium having the first surface to which the treatment agent has been applied to the purge rollers 311 through 313 so that the medium is switched back.

The purge rollers 311 through 313 are conveyance rollers that convey the medium, which has been conveyed by the purge roller 310, along directions E and G illustrated in FIG. 3 to switch back the medium. The medium switched back by the purge rollers 311 through 313 is conveyed along a direction F illustrated in FIG. 3 into the application unit 108a again by the reentry inlet roller 314. In the application unit 108a, a treatment agent is applied to a second surface of the medium. The path in the directions E and G by the purge rollers 311 through 313 can be used as a purge path.

The reentry inlet roller 314 is a conveyance roller that conveys the medium, which has been switched back by the purge rollers 311 through 313, along the direction F to the application unit 108a.

The outlet rollers 315 and 316 are conveyance rollers that convey the medium, which has been conveyed along the directions B and C by the outlet rollers 307 through 309, along the direction J to the registration unit 102.

In the image forming apparatus 100a illustrated in FIG. 2, when the medium reversed by the reverse unit 106 is fed again on an upstream side of the pre-applying unit 108, a treatment agent can be applied to both sides of the medium in the pre-applying unit 108 before the medium is conveyed to the registration unit 102a. However, a treatment agent may be applied to only a first surface of the medium in the pre-applying unit 108, and the resultant medium may be conveyed to the registration unit 102a. In such a case, after the medium is conveyed to the registration unit 102a, an image is formed and printed on the first surface of the medium, and the resultant medium is conveyed via a two-side conveyance path 110a, so that a treatment agent can be applied to a second surface of the medium in the pre-applying unit 108. In this case, since the medium does not need to be switched back inside the pre-applying unit 108, a configuration of the pre-applying unit 108 does not necessarily include the purge rollers 310 through 313 or the reentry inlet roller 314.

Next, a particular configuration of the application unit 108a of the pre-applying unit 108 is described with reference to FIG. 4.

As illustrated in FIG. 4, the application unit 108a includes an application roller 201, a fixation roller 202 (a supply roller), a squeeze roller 203, a pressure roller 204, a pressing roller 205, a treatment agent pan 211, an inlet sensor S1, and an outlet sensor S2. As illustrated in FIG. 4, the squeeze roller 203, the fixation roller 202, the application roller 201, the pressure roller 204, and the pressing roller 205 are arranged in order from a lower side.

The application roller 201 is rotated to apply a liquid treatment agent supplied from a surface of the fixation roller 202 to the bottom surface of the medium conveyed from an upstream conveyance path 212. The application roller 201 includes a metal core formed of a material such as stainless used steel (SUS) 303. Moreover, as illustrated in FIG. 4, the application roller 201 has an elastic layer 201a that is arranged on an outer circumference of the application roller 201. The elastic layer 201a is, for example, formed of polychloroprene rubber.

The fixation roller 202 is a supply roller that is rotated to supply the treatment agent supplied form the squeeze roller 203 to the application roller 201. The fixation roller 202 is, for example, a metal roller formed of SUS303.

The squeeze roller 203 is impregnated with the treatment agent filled into the treatment agent pan 211, and rotation of the squeeze roller 203 supplies the treatment agent to the fixation roller 202. Moreover, the squeeze roller 203 has a function of agitating the treatment agent filled into the treatment agent pan 211. The squeeze roller 203 includes an elastic layer and a metal core. The elastic layer of the squeeze roller 203 is arranged on an outer circumference of the squeeze roller 203, and is formed of a material such as polychloroprene rubber. The metal core of the squeeze roller 203 is, for example, formed of SUS 303.

The pressure roller 204 presses the application roller 201 from above. Moreover, when a medium is conveyed from the upstream conveyance path 212 to the application roller 201, the pressure roller 204 presses the medium with respect to the application roller 201. The pressure roller 204 is, for example, a metal roller formed of SUS303.

The pressing roller 205 applies a load downward with respect to the pressure roller 204 and the application roller 201. The pressing roller 205 is rotated with rotation of the pressure roller 204. The pressing roller 205 includes an elastic layer and a metal core. The elastic layer of the pressing roller 205 is arranged on an outer circumference of the pressing roller 205, and is formed of a material such as polychloroprene rubber. The metal core of the pressing roller 205 is, for example, formed of SUS 303.

After application of the treatment agent to the medium conveyed from the upstream conveyance path 212 by the application roller 201, the medium is conveyed to the side near the outlet roller 306 illustrated in FIG. 3 via a downstream conveyance path 213. The application roller 201, the fixation roller 202, the squeeze roller 203, and the pressure roller 204 are rotated by a same drive source that is a motor 206 described below. Among these rollers, each of the application roller 201 and the squeeze roller 203 is rotated clockwise in the diagram illustrated in FIG. 4, whereas each of the fixation roller 202 and the pressure roller 204 is rotated counterclockwise in the diagram illustrated in FIG. 4.

The treatment agent pan 211 retains the liquid treatment agent.

The inlet sensor S1 detects a medium that has been conveyed on the upstream conveyance path 212. The outlet sensor S2 detects a medium to which a treatment agent has been applied by the application roller 201 and that is to be conveyed on the downstream conveyance path 213.

In such a configuration of the application unit 108a, as illustrated in FIG. 4, a nip portion 214 is formed between the application roller 201 having the elastic layer 201a on the outer circumference and the pressure roller 204, and a nip portion 215 is formed between the application roller 201 and the fixation roller 202. In the nip portion 214, the elastic layer 201a of the application roller 201 receives a nip pressure from the pressure roller 204, and thus is formed into a recess. In the nip portion 215, the elastic layer 201a of the application roller 201 received a nip pressure from the fixation roller 202, and thus is formed into a recess. The medium conveyed from the upstream conveyance path 212 passes through the nip portion 214, so that the treatment agent is applied to the medium from the application roller 201.

### (Hardware Configuration of Image Forming Apparatus)

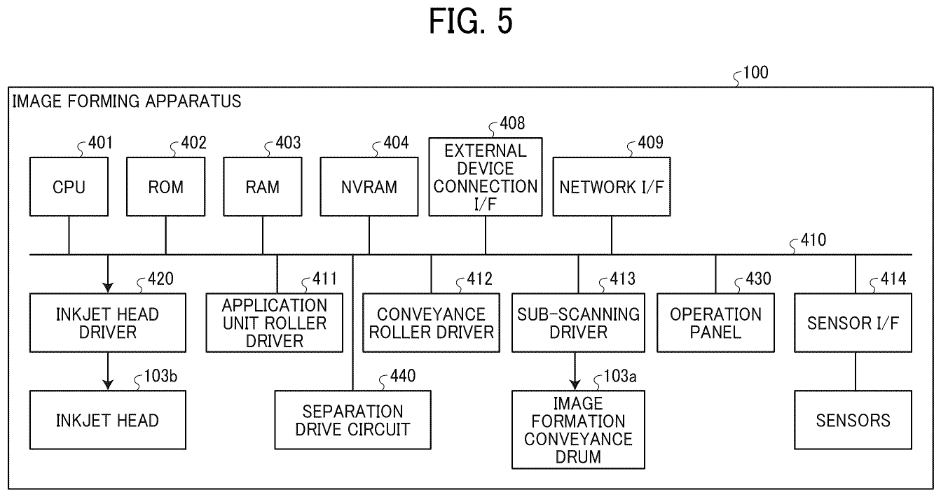

FIG. 5 is a diagram illustrating one example a hardware configuration of the image forming apparatus 100 according to the embodiment of the present disclosure. The hardware configuration of the image forming apparatus 100 is described with reference to FIG. 5.

As illustrated in FIG. 5, the image forming apparatus 100 includes a central processing unit (CPU) 401, a read only memory (ROM) 402, a random access memory (RAM) 403, a non-volatile random access memory (NVRAM) 404, an external device connection interface (I/F) 408, a network I/F 409, an application unit roller driver 411, a conveyance roller driver 412, a sub-scanning driver 413, a sensor I/F 414, an inkjet head driver 420, an operation panel 430, and a separation drive circuit 440.

The CPU 401 is a computation device that comprehensively controls the image forming apparatus 100. The ROM 402 is a non-volatile storage device that stores a program such as an initial program loader (IPL). The RAM 403 is a volatile storage device that is used as a work area of the CPU 401.

The NVRAM 404 is a non-volatile storage device that stores various data such as a program, and retains the various data even when a power source of the image forming apparatus 100 is being interrupted.

The external device connection I/F 408 is an interface that is connected to an external device such as a personal computer (PC) by, for example, a universal serial bus (USB) cable, so that communication is performed between the external device and the external device connection I/F 408 to transmit and receive a control signal and data to be printed.

The network I/F 409 is an interface compliant with transmission control protocol (TCP) or Internet protocol (IP) for data communication via the Internet or a local area network (LAN). Alternatively, the network I/F 409 can be a wire communication interface compliant with a standard such as Ethernet (registered trademark), or a wireless communication interface compliant with a standard such as Wi-Fi (registered trademark).

The application unit roller driver 411 is a drive circuit that drives the motor 206 for rotating the application roller 201, the fixation roller 202, the squeeze roller 203, and the pressure roller 204 of the pre-applying unit 108.

The conveyance roller driver 412 is a drive circuit that independently rotates the inlet rollers 301 through 305, the outlet rollers 306 through 309, the purge rollers 310 through 313, the reentry inlet roller 314, and the outlet rollers 315 and 316.

The sub-scanning driver 413 is a drive circuit that rotates the image formation conveyance drum 103a of the image forming unit 103 to convey a medium in a conveyance direction, that is, a sub-scanning direction.

The sensor I/F 414 is an interface that receives a signal detected by sensors such as the inlet sensor S1 and the outlet sensor S2.

The inkjet head driver 420 is a drive circuit that controls a discharge operation of the inkjet head 103b.

The operation panel 430 is a device including an alarm lamp and a touch panel that receives an operational input from a user. The operation panel 430 displays various screens and setting information about the image forming apparatus 100.

The separation drive circuit 440 is a drive circuit that causes the fixation roller 202 and the pressure roller 204 to move in a direction separating from the application roller 201, and to move to contact the application roller 201 so that the nip portion 214 and the nip portion 215 are formed. The movements of the fixation roller 202 and the pressure roller 204 by the separation drive circuit 440 can be made using a method, for example, a known method using a TR arm, a TR spring, and a TR cam.

The CPU 401, the ROM 402, the RAM 403, the NVRAM 404, the external device connection I/F 408, the network I/F 409, the application unit roller driver 411, the conveyance roller driver 412, the sub-scanning driver 413, the sensor I/F 414, the inkjet head driver 420, the operation panel 430, and the separation drive circuit 440 can perform data communication one another via a bus 410 such as an address bus and a data bus.

Moreover, the hardware configuration of the image forming apparatus 100 illustrated in FIG. 5 is merely one example, and the image forming apparatus 100 does not necessarily include all of the components illustrated in FIG. 5, or may include another component.

### (Application Roller Control Operation)

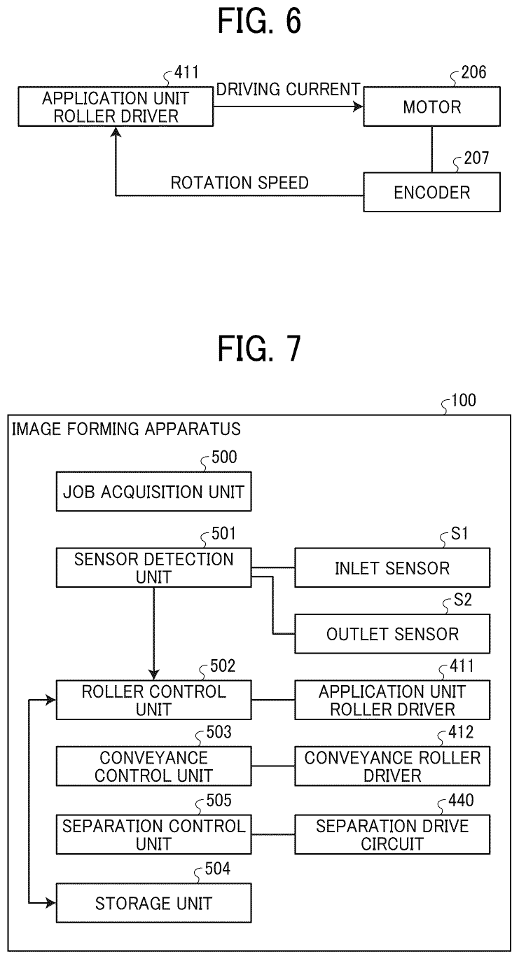

FIG. 6 is a diagram illustrating an operation for controlling the application roller 201 of the application unit 108a of the pre-applying unit 108 in the image forming apparatus 100. The control operation on the application unit 108a of the pre-applying unit 108 in the image forming apparatus 100 according to the present embodiment is described with reference to FIG. 6.

The application unit 108a further includes the motor 206 and an encoder 207 illustrated in FIG. 6.

The motor 206 is an electric motor that rotates the application roller 201, the fixation roller 202, the squeeze roller 203, and the pressure roller 204.

The encoder 207 is a sensor that detects a rotation speed of the motor 206. The encoder 207 transmits the detected rotation speed of the motor 206 to the application unit roller driver 411 described blow.

The application unit roller driver 411 outputs a driving current to the motor 206, which rotates the application roller 201, the fixation roller 202, the squeeze roller 203, and the pressure roller 204 as described above, so that the motor 206 is rotated. The encoder 207 detects a rotation speed of the motor 206, and feeds back the detected rotation speed to the application unit roller driver 411. That is, the application unit roller driver 411 performs feedback control in which a rotation speed (a target rotation speed) that has been set and a rotation speed that has been fed back from the encoder 207 are compared. With the feedback control, the motor 206 can be rotated at the target rotation speed, and each of the application roller 201, the fixation roller 202, the squeeze roller 203, and the pressure roller 204 can be rotated at a desired linear speed. The motor 206 is desirably an alternating current (AC) servomotor having high output and high responsiveness.

### (Functional Block Configuration and Operation of Image Forming Apparatus)

FIG. 7 is a diagram illustrating one example of a function block configuration of the image forming apparatus 100 according to the embodiment of the present disclosure. The functional block configuration and operations of the image forming apparatus 100 according to the present embodiment are described with reference to FIG. 7.

As illustrated in FIG. 7, the image forming apparatus 100 includes a job acquisition unit 500, a sensor detection unit 501, a roller controller 502 (a first controller), a conveyance controller 503, a storage 504, a separation controller 505 (a second controller).

The job acquisition unit 500 is a functional unit that acquires job information including print data as a print target from a device such as an external device via an I/F such as the network I/F 409.

The sensor detection unit 501 is a functional unit that acquires detection signals via the sensor I/F 414. The detection signals indicate that a medium has been detected by the inlet sensor S1 and the outlet sensor S2.

The roller controller 502 is a functional unit that controls rotation of each of the application roller 201, the fixation roller 202, the squeeze roller 203, and the pressure roller 204 via the application unit roller driver 411. Particularly, the roller controller 502 refers to a lookup table stored in the storage 504, and rotates the application roller 201 at a suitable linear speed corresponding to a medium type that is set beforehand. The medium type represents a type of medium conveyed inside the image forming apparatus 100.

The conveyance controller 503 is a functional unit that controls rotation of each of the inlet rollers 301 through 305, the outlet rollers 306 through 309, the purge rollers 310 through 313, the reentry inlet roller 314, and the outlet rollers 315 and 316 of the pre-applying unit 108 via the conveyance roller driver 412.

The storage 504 is a functional unit that stores, for example, the lookup table (one example of a table) in which a medium type is associated with a suitable linear speed that is provided by the application roller 201. The storage 504 is realized by the ROM 402 or the NVRAM 404 illustrated in FIG. 5.

The separation controller 505 is a functional unit that controls movements of the fixation roller 202 and the pressure roller 204 via the separation drive circuit 440. The separation controller 505 causes the fixation roller 202 and the pressure roller 204 to move in a direction separating from the application roller 201 and to move to contact the application roller 201 so that the nip portion 214 and the nip portion 215 are formed.

Each of the job acquisition unit 500, the sensor detection unit 501, the roller controller 502, the conveyance controller 503, and the separation controller 505 described above is realized by execution of a program by the CPU 401 illustrated in FIG. 5. At least one portion of the job acquisition unit 500, the sensor detection unit 501, the roller controller 502, the conveyance controller 503, and the separation controller 505 can be implemented by a hardware circuit such as a field programmable gate array (FPGA) or an application specific integrated circuit (ASIC).

Although a function of each functional unit of the image forming apparatus 100 illustrated in FIG. 7 has been conceptionally described, the configuration of the functional units of the image forming apparatus 100 is not limited thereto. That is, each of the functional units of the image forming apparatus 100 may not necessarily be configured as a distinctive software module as a block illustrated in FIG. 7 as long as functions of the respective functional units can be comprehensively implemented by execution of a program by the image forming apparatus 100. For example, a plurality of functional units each of which is an independent functional unit in the image forming apparatus 100 illustrated in FIG. 7 may be configured as one functional unit. On the other hand, a function of one functional unit of the image forming apparatus 100 illustrated in FIG. 7 may be divided into a plurality of segments. In such a case, the one functional unit can be configured as a plurality of functional units.

### (Operation of Pre-Applying Unit of Image Forming Apparatus in Comparative Example)

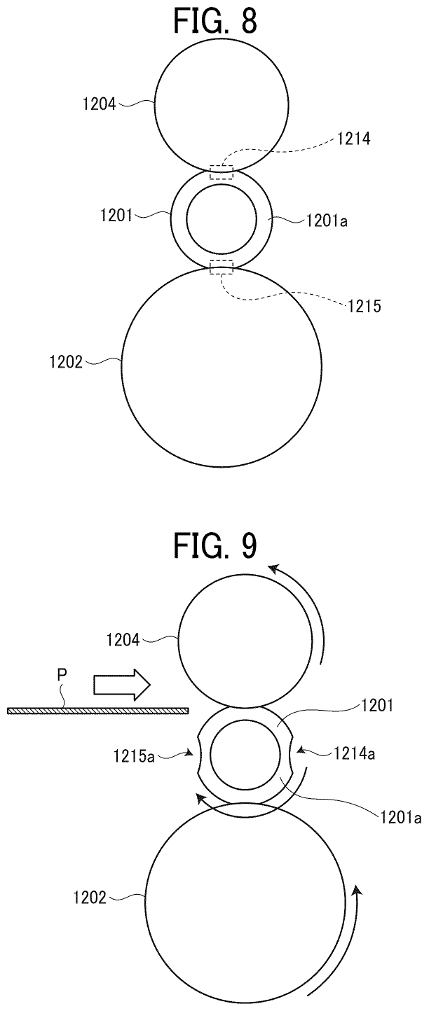

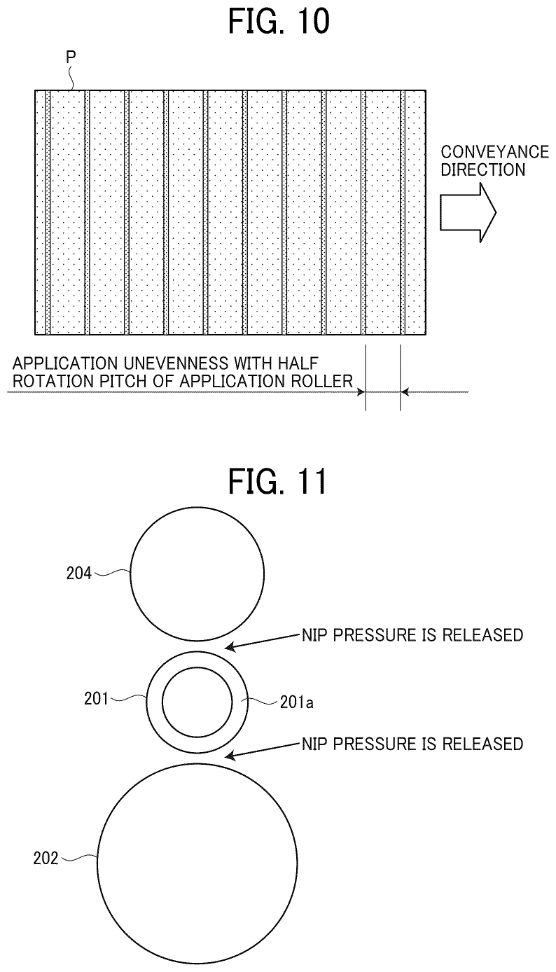

FIG. 8 is a diagram illustrating a preparation state prior to application of a treatment agent in an application unit of a pre-applying unit of an image forming apparatus in a comparative example. FIG. 9 is a diagram illustrating a state when the treatment agent is applied to a medium in the application unit of the pre-applying unit of the image forming apparatus in the comparative example. FIG. 10 is a diagram illustrating a state in which banding-shaped application unevenness is generated on a medium to which the treatment agent has been applied by the pre-applying unit of the image forming apparatus in the comparative example. The operation of the pre-applying unit of the image forming apparatus in the comparative example is described with reference to FIGS. 8 through 10.

In FIG. 8, a configuration of an application roller 1201, a fixation roller 1202 and a pressure roller 1204 is illustrated, out of a configuration of an application unit of the preferably-applying unit of the image forming apparatus in the comparative example. The application roller 1201 has an elastic layer 1201a that is arranged on an outer circumference of the application roller 1201. In such a configuration, a nip portion 1214 is formed between the application roller 1201 having the elastic layer 201a on the outer circumference and the pressure roller 1204, whereas a nip portion 1215 is formed between the application roller 1201 and the fixation roller 1202. Before job information is acquired, the application roller 1201 and the fixation roller 1202 are separated, the application roller 1201 and the pressure roller 1204 are separated, and each of the application roller 1201, the fixation roller 1202, and the pressure roller 1204 is in a non-rotation state, as similar to the image forming apparatus 100 according to the present embodiment described below.

When the image forming apparatus acquires job information, a medium P is fed from a sheet feeding unit. Thus, before the medium P reaches the application unit of the pre-applying unit, preparation for an application operation to be performed by the application roller 1201 needs to be completed. Accordingly, in the comparative example as illustrated in FIG. 8, when the image forming apparatus acquires job information, each of the fixation roller 1202 and the pressure roller 1204 contacts the application roller 1201 in a state in which each of the application roller 1201, the fixation roller 1202, and the pressure roller 1204 remains in the non-rotation state, and the nip portion 1214 and the nip portion 1215 are respectively formed between the application roller 1201 and the pressure roller 1204 and between the application roller 1201 and the fixation roller 1202. Accordingly, each of the application roller 1201, the fixation roller 1202, and the pressure roller 1204 is on standby in the state illustrated in FIG. 8.

Then, as illustrated in FIG. 9, when the medium P reaches the application unit and an application operation is performed using the application roller 1201, the application roller 1201, the fixation roller 1202, and the pressure roller 1204 start to rotate. However, since the application roller 1201, the fixation roller 1202, and the pressure roller 1204 have been on standby in the state as illustrated in FIG. 8, the elastic layer 1201a of the application roller 1201 has portions to which nip pressure have been applied from the fixation roller 1202 and the pressure roller 1204, causing generation of two recessed areas 1214a and 1215a with a 180-dgree pitch in such portions as illustrated in FIG. 9. Consequently, when the medium P is inserted into the nip portion between the application roller 1201 and the pressure roller 1204, an amount of treatment agent is increased due to the recessed areas 1214a and 1215a. This causes generation of banding-shaped application unevenness with a half rotation pitch of the application roller 1201 as illustrated in FIG. 10. In the image forming apparatus 100 according to the present embodiment described below, on the other hand, generation of banding-shaped application unevenness due to such a treatment agent can be reduced.

### (Details of Operation of Application Unit of Pre-Applying Unit of Image Forming Apparatus)

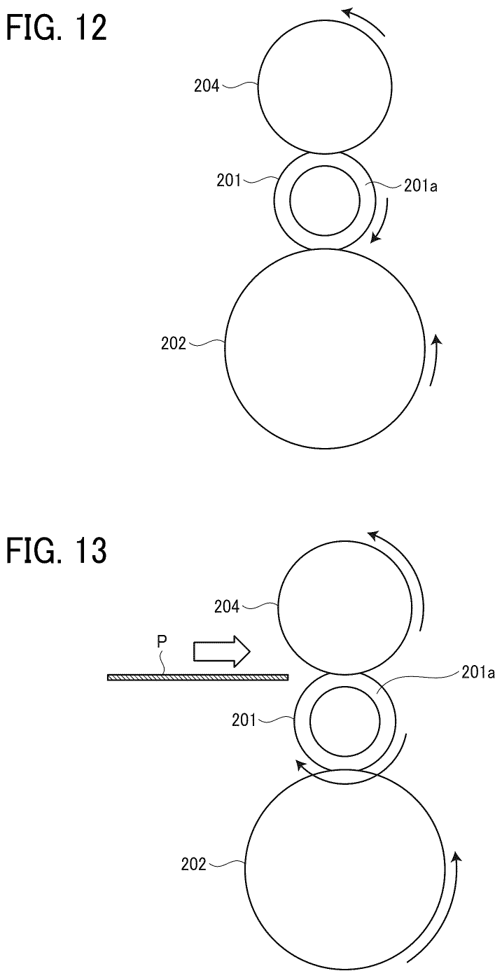

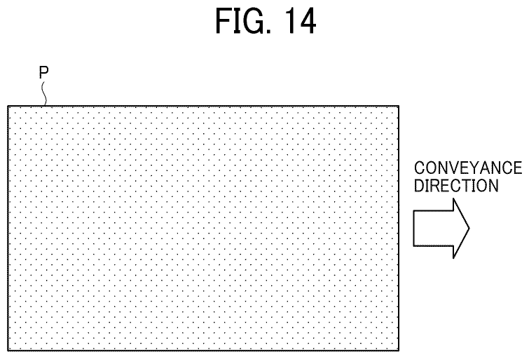

FIG. 11 is a diagram illustrating a non-operating state in the application unit 108a of the pre-applying unit 108 of the image forming apparatus 100 according to the present embodiment. FIG. 12 is a diagram illustrating a preparation state prior to application of a treatment agent in the application unit 108a of the pre-applying unit 108 of the image forming apparatus 100 according to the present embodiment. FIG. 13 is a diagram illustrating a state when the treatment agent is applied in the application unit 108a of the pre-applying unit 108 of the image forming apparatus 100 according to the present embodiment. FIG. 14 is a diagram illustrating a state of a medium to which the treatment agent has been applied by the pre-applying unit 108 of the image forming apparatus 100 according to the present embodiment. An operation of the application unit 108a of the pre-applying unit 108 of the image forming apparatus 100 according to the present embodiment is described in detail with reference to FIGS. 11 through 14.

In the application unit 108a of the pre-applying unit 108 according to the present embodiment, the separation controller 505 causes the application roller 201 and the fixation roller 202 to be separated from each other and the application roller 201 and the pressure roller 204 to be separated from each other via the separation drive circuit 440 to release nip pressure as illustrated in FIG. 11 before job information is acquired by the job acquisition unit 500. In this state, the roller controller 502 controls each of the application roller 201, the fixation roller 202, and the pressure roller 204 to be in a non-rotation state.

Next, when the job information is acquired by the job acquisition unit 500, a medium is fed from the sheet feeding unit 101. Thus, as similar to the comparative example described above, before the medium reaches the application unit 108a of the pre-applying unit 108, preparation for an application operation to be performed by the application roller 201 needs to be completed. However, when the application roller 201 is rotated, a treatment agent to be supplied from the squeeze roller 203 and the fixation roller 202 is exposed to the air. Since the exposure of the treatment agent to the air causes moisture in the treatment agent to evaporate, a viscosity of the treatment agent increases.

Consequently, quality of the treatment agent is degraded. In addition, in a case where the application roller 201 is rotated fast, the treatment agent is exposed to the air more frequently. In the present embodiment, when job information is acquired by the job acquisition unit 500, as illustrated in FIG. 12, the separation controller 505 first causes each of the fixation roller 202 and the pressure roller 204 to contact the application roller 201, thereby forming the nip portion 214 between the application roller 201 and the pressure roller 204 and the nip portion 215 between the application roller 201 and the fixation roller 202.

Then, as illustrated in FIG. 12, the roller controller 502 rotates each of the application roller 201, the fixation roller 202, and the pressure roller 204 at a rotation speed to be a linear speed lower than a linear speed corresponding to the medium for a duration of time from when the job information is acquired by the job acquisition unit 500 to when the medium reaches the application roller 201. For example, the roller controller 502 desirably rotates the application roller 201 at a rotation speed to be a linear speed that is 1/10 or less of a linear speed that corresponds to the medium and is defined by the lookup table stored in the storage 504.

Accordingly, the application roller 201, the fixation roller 202, and the pressure roller 204 are rotated slowly, thereby not only reducing an increase in viscosity of the treatment agent but also reducing formation of recessed areas due to the nip pressure from the fixation roller 202 and the pressure roller 204.

When the medium P reaches the application roller 201 and an application operation is performed by the application roller 201, as illustrated in FIG. 13, the roller controller 502 rotates each of the application roller 201, the fixation roller 202, and the pressure roller 204 at a rotation speed to be a linear speed (a linear speed defined in the lookup table stored in the storage 504) corresponding to the medium P. Herein, when the medium P is detected by the inlet sensor S1, it can be determined that the medium P has reached the application roller 201. Accordingly, since the treatment agent is applied to the medium P by the application roller 201 in a state in which a recessed area of the application roller 201 is reduced, generation of banding-shaped application unevenness due to the treatment agent can be reduced as illustrated in FIG. 14.

In the pre-applying unit 108 of the image forming apparatus 100 according to the present embodiment, therefore, the application roller 201 applies a treatment agent to a medium to be conveyed, the pressure roller 204 presses the application roller 201, the fixation roller 202 supplies the treatment agent to the application roller 201, and the roller controller 502 rotates the application roller 201 for a duration of time from when job information is acquired by the image forming apparatus 100 to when the medium reaches the application roller 201. Accordingly, since the treatment agent is applied to the medium by the application roller 201 in a state in which a recessed area of the application roller 201 is reduced, generation of banding-shaped application unevenness due to the treatment agent can be reduced.

In the pre-applying unit 108 of the image forming apparatus 100 according to the present embodiment, moreover, the roller controller 502 rotates the application roller 201 at a rotation speed to be a linear speed lower than a linear speed corresponding to the medium for a duration of time from when job information is acquired by the image forming apparatus 100 to when the medium reaches the application roller 201. Accordingly, not only an increase in viscosity of the treatment agent can be reduced, but also formation of recessed areas due to the nip pressure from the fixation roller 202 and the pressure roller 204 can be reduced.

In the above-described embodiment, in a case where at least any of the functional units of the image forming apparatus 100 is realized by execution of a program, the program is incorporated beforehand into a memory such as a ROM. In the above-described embodiment, moreover, a program to be executed by the image forming apparatus 100 can be recorded and provided as a file in an installable format or executable format in a computer-readable recording medium such as a compact disc read only memory (CD-ROM), a flexible disk (FD), a compact disc recordable (CD-R), or a digital versatile disk (DVD). In the above-described embodiment, a program to be executed by the image forming apparatus 100 can be stored in a computer connected to a network such as the Internet, and such a program can be downloaded via the network.

In the above-described embodiment, a program to be executed by the image forming apparatus 100 can be provided or distributed via a network such as the Internet. In the above-described embodiment, the program to be executed by the image forming apparatus 100 has a module configuration including at least any of the aforementioned functional units, and the CPU 401 reads out the program from the aforementioned storage device (e.g., a memory such as the ROM 402 and the NVRAM 404) and executes the program, so that each of the functional units described above is loaded to a main storage device (the RAM 403) and is realized as actual hardware.

A treatment-agent liquid applicator includes an application roller to apply a treatment agent to a medium to be conveyed to an image forming apparatus, a pressure roller to press the medium against the application roller, a supply roller to supply the treatment agent to the application roller; and circuitry configured to rotate the application roller for a duration of time, from when job information is acquired by the image forming apparatus, to when the medium reaches the application roller.

The circuitry rotates the application roller at a rotation speed for the duration of time; and controls the rotation speed to be a first linear speed lower than a second linear speed corresponding to the medium. The circuitry simultaneously rotates the application roller, the pressure roller, and the supply roller. The circuitry rotates the application roller at a rotation speed to be the first linear speed that is 1/10 or less of the second linear speed for the duration of time. The circuitry rotates the application roller at a rotation speed to be the second linear speed after the medium reaches the application roller.

The circuitry simultaneously rotates the application roller, the pressure roller, and the supply roller after the medium reaches the application roller. The treatment-agent liquid applicator includes a storage to store a table including a linear speed of the application roller is associated with a type of medium, and the second linear speed. The circuitry rotates the application roller at a rotation speed to be the first linear speed lower than the second linear speed in the table stored in the storage for the duration of time.

The circuitry, before the job information is acquired by the image forming apparatus: separates each of the pressure roller and the supply roller from the application roller; and controls to stop each of the application roller, the pressure roller, and the supply roller from rotating. The circuitry controls each of the pressure roller and the supply roller to contact the application roller when the job information is acquired by the image forming apparatus. An image forming apparatus includes the treatment-agent liquid applicator to apply the treatment agent onto the medium, and a discharge head to discharge a liquid to the medium, onto which the treatment agent has been applied by the treatment-agent liquid applicator, to form an image.

According to the present embodiment, generation of banding-shaped application unevenness due to a treatment agent can be reduced.

The present embodiment has aspects as follows.

### <First Aspect>

A treatment-agent liquid applicator that is disposed in an image forming apparatus includes an application roller, a pressure roller, a supply roller, and a first controller. The application roller applies a treatment agent to a recording medium to be conveyed. The pressure roller presses the application roller. The supply roller supplies the treatment agent to the application roller. The first controller rotates the application roller for a duration of time from when job information is acquired by the image forming apparatus to when the medium reaches the application roller.

### <Second Aspect>

In the treatment-agent liquid applicator with the first aspect, for a duration of time from when job information is acquired by the image forming apparatus to when the medium reaches the application roller, the first controller rotates the application roller at a rotation speed to be a linear speed lower than a linear speed corresponding to the medium.

### <Third Aspect>

In the treatment-agent liquid applicator with the first or second aspect, the first controller simultaneously rotates the application roller, the pressure roller, and the supply roller.

### <Fourth Aspect>

In the treatment-agent liquid applicator with the second aspect, for a duration of time from when job information is acquired by the image forming apparatus to when the medium reaches the application roller, the first controller rotates the application roller at a rotation speed to be a linear speed that is 1/10 or less of a linear speed corresponding to the medium.

### <Fifth Aspect>

In the treatment-agent liquid applicator with any one of the first through fourth aspects, after the medium reaches the application roller, the first controller rotates the application roller at a rotation speed to be a linear speed corresponding to the medium.

### <Sixth Aspect>

In the treatment-agent liquid applicator with the fifth aspect, after the medium reaches the application roller, the first controller simultaneously rotates the application roller, the pressure roller, and the supply roller.

### <Seventh Aspect>

The treatment-agent liquid applicator with the second aspect further includes a storage that stores a table in which a linear speed of the application roller is associated with a recording medium type, In such a treatment-agent liquid applicator, for a duration of time from when job information is acquired by the image forming apparatus to when the medium reaches the application roller, the first controller rotates the application roller at a rotation speed to be a linear speed lower than a linear speed that corresponds to the recording medium and is defined in the table stored in the storage.

### <Eighth Aspect>

The treatment-agent liquid applicator with any one of the first through seventh aspects further includes a second controller that separates each of the pressure roller and the supply roller from the application roller before job information is acquired by the image forming apparatus. In such a treatment-agent liquid applicator, before job information is acquired by the image forming apparatus, the first controller controls each of the application roller, the pressure roller, and the supply roller to be in a non-rotation state.

### <Ninth Aspect>

In the treatment-agent liquid applicator with the eighth aspect, when job information is acquired by the image forming apparatus, the second controller causes each of the pressure roller and the supply roller to contact the application roller.

### <Tenth Aspect>

An image forming apparatus includes the treatment-agent liquid applicator with any one of the first through ninth aspects and a discharge head. The discharge head discharges ink to the recording medium to which the treatment agent has been applied by the treatment-agent liquid applicator to form an image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A treatment-agent liquid applicator comprising:
an application roller to apply a treatment agent to a medium to be conveyed to an image forming apparatus;
a pressure roller to press the medium against the application roller;
a supply roller to supply the treatment agent to the application roller; and
circuitry configured to rotate the application roller for a duration of time, from when job information is acquired by the image forming apparatus, to when the medium reaches the application roller.

2. The treatment-agent liquid applicator according to claim 1,
wherein, the circuitry:
rotates the application roller at a rotation speed for the duration of time; and
controls the rotation speed to be a first linear speed lower than a second linear speed corresponding to the medium.

3. The treatment-agent liquid applicator according to claim 1,
wherein the circuitry simultaneously rotates the application roller, the pressure roller, and the supply roller.

4. The treatment-agent liquid applicator according to claim 2,
wherein the circuitry rotates the application roller at a rotation speed to be the first linear speed that is 1/10 or less of the second linear speed for the duration of time.

5. The treatment-agent liquid applicator according to claim 2,
wherein the circuitry rotates the application roller at a rotation speed to be the second linear speed after the medium reaches the application roller.

6. The treatment-agent liquid applicator according to claim 5,
wherein the circuitry simultaneously rotates the application roller, the pressure roller, and the supply roller after the medium reaches the application roller.

7. The treatment-agent liquid applicator according to claim 2, further comprising:
a storage to store a table including:
a linear speed of the application roller is associated with a type of medium; and
the second linear speed,
wherein the circuitry rotates the application roller at a rotation speed to be the first linear speed lower than the second linear speed in the table stored in the storage for the duration of time.

8. The treatment-agent liquid applicator according to claim 1,
wherein the circuitry, before the job information is acquired by the image forming apparatus:
separates each of the pressure roller and the supply roller from the application roller; and
controls to stop each of the application roller, the pressure roller, and the supply roller from rotating.

9. The treatment-agent liquid applicator according to claim 8,
wherein the circuitry controls each of the pressure roller and the supply roller to contact the application roller when the job information is acquired by the image forming apparatus.

10. An image forming apparatus comprising:
the treatment-agent liquid applicator according to claim 1 to apply the treatment agent onto the medium; and
a discharge head to discharge a liquid to the medium, onto which the treatment agent has been applied by the treatment-agent liquid applicator, to form an image.
